(19) United States
(12) Patent Application Publication
(10) Pub. No.: US 2018/0060240 A1
(43) Pub. Date: Mar. 1, 2018

(54) FACE RECOGNITION USING STAGE-WISE MINI BATCHING TO IMPROVE CACHE UTILIZATION

(71) Applicant: NEC Laboratories America, Inc., Princeton, NJ (US)

(72) Inventors: Asim Kadav, Jersey City, NJ (US); Farley Lai, Princeton, IA (US)

(21) Appl. No.: 15/678,889

(22) Filed: Aug. 16, 2017

Related U.S. Application Data
(60) Provisional application No. 62/380,573, filed on Aug. 29, 2016.

(51) Int. Cl. G06F 12/0875; G06K 9/00; G06K 9/66; G06N 99/00; G06N 3/02

(52) U.S. Cl. CPC G06F 12/0875; G06K 9/00255; G06K 9/00288; G06F 2212/455; G06K 9/00986; G06N 99/005; G06N 3/02; G06K 9/66

(57) ABSTRACT

A face recognition system and method for face recognition are provided. The face recognition system includes a camera for capturing an input image of a face of a person to be recognized. The face recognition system further includes a cache. The face recognition system further includes a set of one or more processors configured to (i) improve a utilization of the cache by the one or more processors during multiple training stages of a neural network configured to perform face recognition, by performing a stage-wise mini-batch process on a set of samples used for the multiple training stages, and (ii) recognize the person by applying the neural network to the input image during a recognition stage. The stage-wise mini-batch process waits for each of the multiple training stages to complete using a system wait primitive to improve the utilization of the cache.

### RELATED APPLICATION INFORMATION

This application claims priority to U.S. Provisional Pat. App. Ser. No. 62/380,573, filed on Aug. 29, 2016, incorporated herein by reference herein its entirety. This application is related to an application entitled “Stage-Wise Mini Batching To Improve Cache Utilization”, having attorney docket number 16026A, and which is incorporated by reference herein in its entirety.

### BACKGROUND

### Technical Field

The present invention relates to machine learning and more particularly to face recognition using stage-wise mini batching to improve cache utilization.

### Description of the Related Art

In practice, machine learning model training processes data examples in batches to improve training performance. Instead of processing a single data example and training and updating the model parameters, one can train over a batch of samples to calculate an average gradient and then update the model parameters. However, computing a mini-batch over multiple samples can be slow and computationally efficient. Thus, there is a need for a mechanism for efficient mini-batching.

### SUMMARY

According to an aspect of the present invention, a face recognition system is provided. The face recognition system includes a camera for capturing an input image of a face of a person to be recognized. The face recognition system further includes a cache. The face recognition system further includes a set of one or more processors configured to (i) improve a utilization of the cache by the one or more processors during multiple training stages of a neural network configured to perform face recognition, by performing a stage-wise mini-batch process on a set of samples used for the multiple training stages, and (ii) recognize the person by applying the neural network to the input image during a recognition stage. The stage-wise mini-batch process waits for each of the multiple training stages to complete using a system wait primitive to improve the utilization of the cache.

According to another aspect of the present invention, a computer-implemented method is provided for face recognition. The method includes improving a cache utilization by one or more processors during multiple training stages of a neural network configured to perform face recognition, by performing a stage-wise mini-batch process on a set of samples used for the multiple training stages. The stage-wise mini-batch process waits for each of the multiple training stages to complete using a system wait primitive to improve the cache utilization. The method further includes capturing, by a camera, an input image of a face of a person to be recognized. The method also includes recognizing the person by applying the neural network to the input image during a recognition stage.

According to yet another aspect of the present invention, a computer program product is provided for face recognition. The computer program product includes a non-transitory computer readable storage medium having program instructions embodied therewith. The program instructions executable by a computer to cause the computer to perform a method. The method includes improving a cache utilization by one or more processors during multiple training stages of a neural network configured to perform face recognition, by performing a stage-wise mini-batch process on a set of samples used for the multiple training stages. The stage-wise mini-batch process waits for each of the multiple training stages to complete using a system wait primitive to improve the cache utilization. The method further includes capturing, by a camera, an input image of a face of a person to be recognized. The method also includes recognizing the person by applying the neural network to the input image during a recognition stage.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary system for stage-wise mini batching, in accordance with an embodiment of the present invention;

FIG. 2 shows an exemplary distributed system for stage-wise mini batching, in accordance with an embodiment of the present principles;

FIG. 3 shows an exemplary processing system to which the present principles may be applied, in accordance with an embodiment of the present principles;

FIG. 4 shows an exemplary method for stage-wise mini batching, in accordance with an embodiment of the present principles;

FIG. 5 shows an example of conventional mini-batching to which the present invention can be applied, in accordance with an embodiment of the present invention; and

FIG. 6 shows an example of mini-batching, in accordance with an embodiment of the present invention.

### DETAILED DESCRIPTION OF PREFERRED EMBODIMENTS

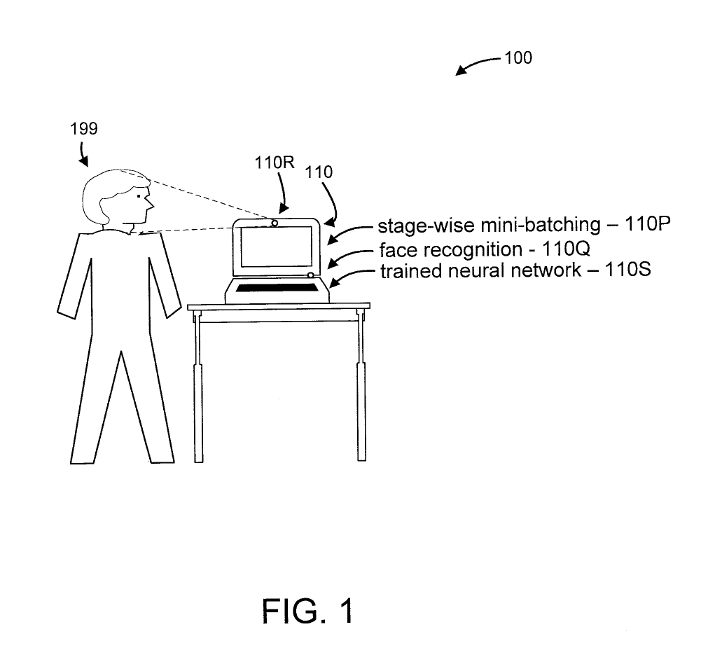

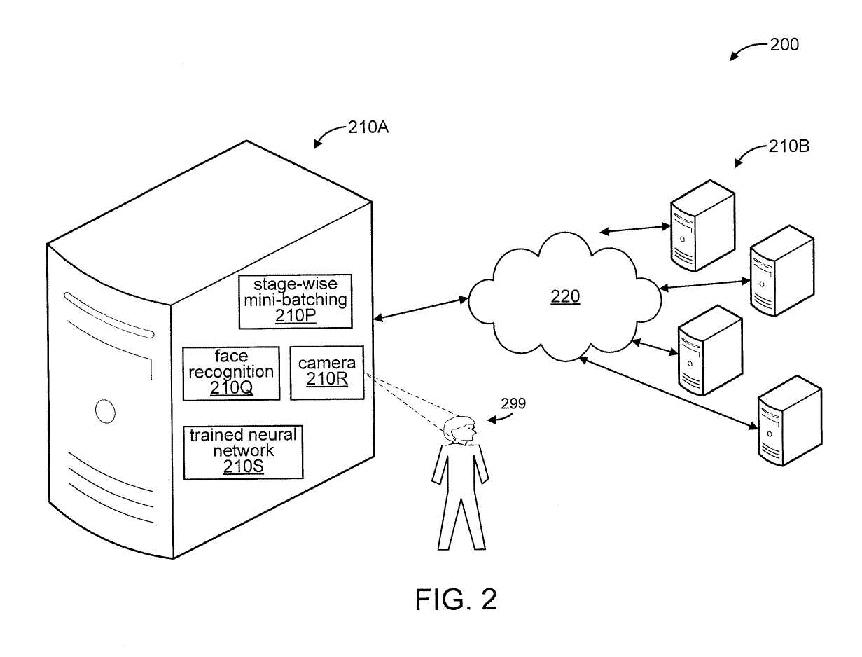

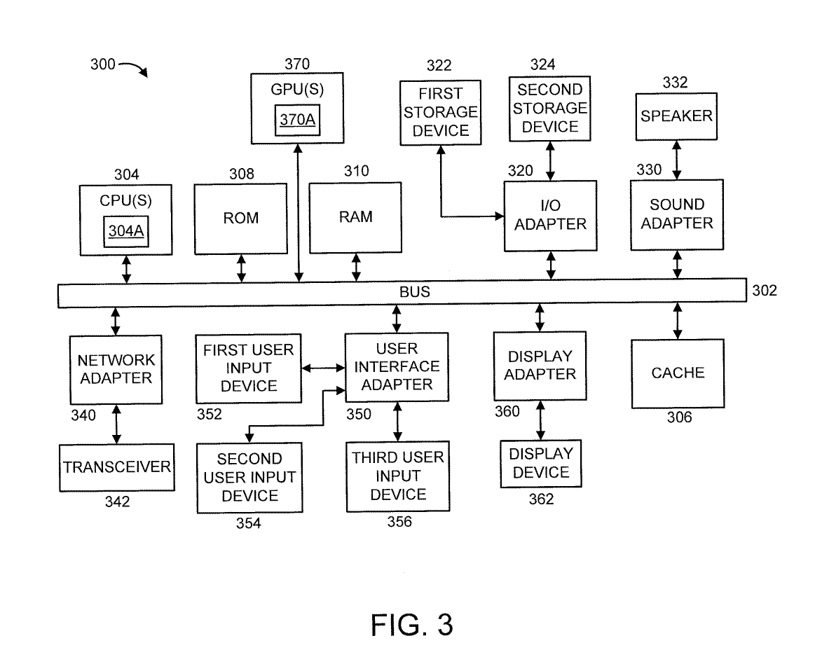

The present invention is directed to face recognition using stage-wise mini batching to improve cache utilization. In an embodiment, the present invention provides a mini-batching method to speedup machine learning training in a single system (e.g., as shown in FIG. 1 and FIG. 3) or a distributed system environment (as shown in FIG. 2).

In an embodiment, the present invention provides a solution to improve mini-batching performance in deep learning (neural networks) by improving cache utilization. For example, for deep-learning networks, training is usually performed in the following three stages: (1) a forward propagation stage (“forward propagation” in short); (2) a backward propagation stage (“backward propagation” in short); and (3) an adjust stage. In the forward propagation stage, an input example is processed through the deep network and an output is computed using this example and the weights in the network. In the backward propagation stage, based on the differences between the output and the expected output, a gradient is calculated for each of the weights. In the adjust stage, the network weights are adjusted based on this gradient value.

Since processing a single example is slow, a batch of examples is processed at once. Often this means running multiple threads at once, or running multiple threads with an input vector of examples (instead of a single example), transforming many matrix vector operations to matrix-matrix operations. However, these multiple threads can be processing different stages at the same time, thus adversely impacting the cache.

The present invention proposes performing mini-batching in deep networks and waiting for each stage to finish using a system wait primitive such as a barrier( ) operation in the case of single or distributed systems. This improves the cache utilization of the overall system(s). That is, by adding a barrier after each state, cache utilization is improved since all threads have greater overlapping of the working set (that is, the amount of memory a process requires in a given time period). Accordingly, a higher throughput of trained samples per second can be achieved.

In an embodiment, the present invention proposes blocking all threads after each stage to improve the overall cache utilization. The threads can be blocked using wait primitives such as parallel barriers or any other fine-grained synchronization primitives. For example, fine-grained synchronization primitives that can be used by the present invention include, but are not limited to, the following: locks; semaphores; monitors; message passing; and so forth. It is to be appreciated that the preceding primitive types are merely illustrative and, thus, other primitive types can also be used in accordance with the teachings of the present invention, while maintaining the spirit of the present invention.

In an embodiment, the present invention can be used to improve training throughput in different types of processing hardware such as CPUs, GPUs, and/or specialized hardware (e.g., Application Specific Integrated Circuits (ASICs), etc.). This results in faster operation and higher utilization of the hardware.

FIG. 1 shows an exemplary system 100 for stage-wise mini batching, in accordance with an embodiment of the present invention. The system 100 can utilize stage-wise mini-batching in a myriad of applications including, but not limited to, face recognition, fingerprint recognition, voice recognition, pattern recognition, and so forth. Hereinafter, system 100 will be described generally and will further be described with respect to face recognition.

The system 100 includes a computer processing system 110. The computer processing system 110 is specifically configured to perform stage-wise mini batching 110P in accordance with an embodiment of the present invention. Moreover, in an embodiment, the computer processing system 110 can be further configured to perform face recognition 110Q using stage-wise mini batching 110A. In such a case, computer processing system 110 can include a camera 110R for capturing one or more images of a person 191 to be recognized based on their face (facial features). In this way, a trained neural network 110S is provided where training performance is improved. That is, training of a neural network can be improved with respect to overall computer utilization and computer resource consumption for any application that can employ stage-wise mini batching including face recognition.

FIG. 2 shows an exemplary distributed system 200 for stage-wise mini batching, in accordance with an embodiment of the present principles. Similar to system 100, system 200 can utilize stage-wise mini-batching in a myriad of applications including, but not limited to, face recognition, fingerprint recognition, voice recognition, pattern recognition, and so forth. Hereinafter, system 200 will be described generally and will further be described with respect to face recognition.

The distributed system 200 includes a set of servers 210. The set of servers 210 are interconnected by one or more networks (hereinafter “network” in short) 220. The set of servers 210 can be configured to perform stage-wise mini-batching in accordance with the present invention using a distributed approach in order to train a neural network. Moreover, in an embodiment, the system 210 can be further configured to perform face recognition 210Q using stage-wise mini batching 210P. In such a case, one or more over the servers 210 can include a camera 210R for capturing one or more images of a person 291 to be recognized based on their face (facial features). In this way, a trained neural network 210S is provided where training performance is improved. That is, training of a neural network can be improved with respect to overall computer utilization and computer resource consumption for any application that can employ stage-wise mini batching including face recognition.

In an embodiment, the servers 210 can be configured to collectively perform stage-wise mini-batching in accordance with the present invention by having different servers perform different stages of the neural network training. For example, in an embodiment, the servers 210 can be configured to have a master server 210A (from among the servers 210) manage (e.g., collect and process) the results obtained one or multiple slave servers 210B (from among the servers 210), where each of the slave servers 210B performs a different neural network training stage. As another example, in another embodiment, two or more of the servers can be used to perform each of the stages. These and other variations of distributed server use with respect to the present invention are readily determined by one of ordinary skill in the art given the teachings of the present invention provided herein, while maintaining the spirit of the present invention.

FIG. 3 shows an exemplary processing system 300 to which the present principles may be applied, according to an embodiment of the present principles, is shown. The processing system 300 includes a set of processors (hereinafter interchangeably referred to as “CPU(s)”) 304 operatively coupled to other components via a system bus 302. A cache 306, a Read Only Memory (ROM) 308, a Random Access Memory (RAM) 310, an input/output (I/O) adapter 320, a sound adapter 330, a network adapter 340, a user interface adapter 350, a display adapter 360, and a set of Graphics Processing Units (hereinafter interchangeably referred to as “GPU(s)”) 370 are operatively coupled to the system bus 302.

In an embodiment, at least one of CPU(s) 304 and/or GPU(s) 370 is a multi-core processor configured to perform simultaneous multithreading. In an embodiment, at least one CPU(s) 304 and/or GPU(s) 370 is a multi-core superscalar symmetric processor. In an embodiment, different processors in the set 304 and/or different GPUs in the set 370 can be used to perform different stages of neural network training. In an embodiment, there can be overlap between two or more CPUs and/or GPUs with respect to a given stage. In an embodiment, different cores are used to perform different stages of neural network training. In an embodiment, there can be overlap between two or more cores with respect to a given stage.

While a separate cache 306 is shown, in the embodiment of FIG. 3, each of the CPU(s) 304 and GPU(s) 370 include on-chip caches 304A and 370A, respectively. The present invention can improve cache utilization of any of caches 304A, 370A, and 306. These and other advantages of the present invention are readily determined by one of ordinary skill in the art, given the teachings of the present invention provided herein, while maintaining the spirit of the present invention. Moreover, it is to be appreciated in other embodiments, one or more of the preceding caches may be omitted and other caches added (e.g., in a different configuration).

A first storage device 322 and a second storage device 324 are operatively coupled to system bus 302 by the I/O adapter 320. The storage devices 322 and 324 can be any of a disk storage device (e.g., a magnetic or optical disk storage device), a solid state magnetic device, and so forth. The storage devices 322 and 324 can be the same type of storage device or different types of storage devices.

A speaker 332 is operatively coupled to system bus 302 by the sound adapter 330. A transceiver 342 is operatively coupled to system bus 302 by network adapter 340. A display device 362 is operatively coupled to system bus 302 by display adapter 360.

A first user input device 352, a second user input device 354, and a third user input device 356 are operatively coupled to system bus 302 by user interface adapter 350. The user input devices 352, 354, and 356 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 352, 354, and 356 can be the same type of user input device or different types of user input devices. The user input devices 352, 354, and 356 are used to input and output information to and from system 300.

Of course, the processing system 300 may also include other elements (not shown), as readily contemplated by one of skill in the art, as well as omit certain elements. For example, various other input devices and/or output devices can be included in processing system 300, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 300 are readily contemplated by one of ordinary skill in the art given the teachings of the present principles provided herein.

Moreover, it is to be appreciated that system 100 described above with respect to FIG. 1 is a system for implementing respective embodiments of the present principles. Part or all of processing system 200 may be implemented in one or more of the elements of system 100. Also, it is to be appreciated that system 200 described above with respect to FIG. 2 is a system for implementing respective embodiments of the present principles. Part or all of processing system 300 may be implemented in one or more of the elements of system 200.

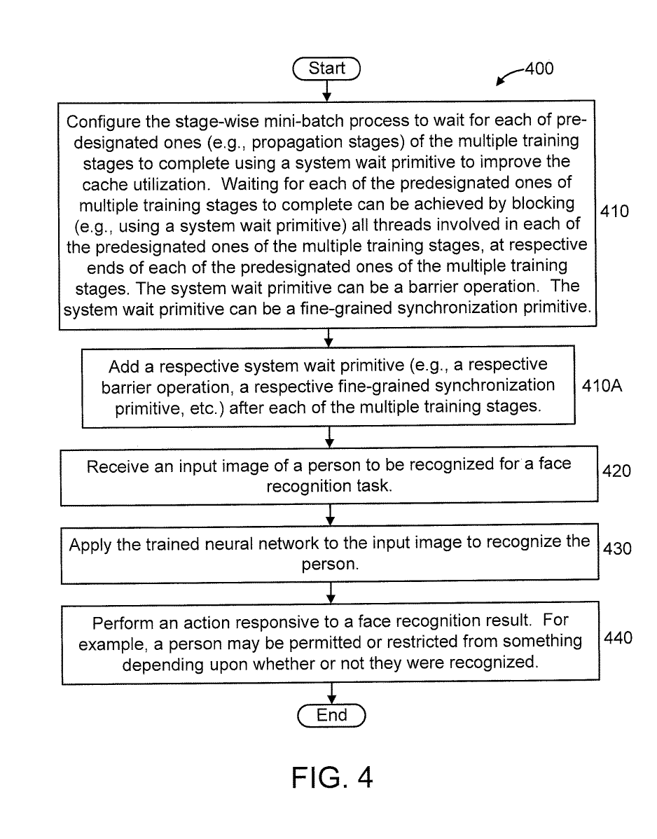

Further, it is to be appreciated that processing system 100 may perform at least part of the method described herein including, for example, at least part of method 400 of FIG. 4. Similarly, part or all of system 200 may be used to perform at least part of method 400 of FIG. 4. Also, part or all of system 300 may be used to perform at least part of method 400 of FIG. 4.

FIG. 4 shows an exemplary method 400 for stage-wise mini batching, in accordance with an embodiment of the present principles.

At step 410, improve a cache utilization by one or more processors during multiple training stages of a neural network, by performing a stage-wise mini-batch process on a set of samples used for the multiple training stages. In an embodiment, the one or more processors can include at least one graphics processing unit. In an embodiment, the one or more processors can include at least two separate processing devices in at least two computers of a distributed computer system. In an embodiment, the stage-wise mini-batch process can be applied to all of the propagation stages of the multiple training stages of the neural network. In an embodiment, the multiple training stages can include a forward propagation stage, a backward propagation stage, and an adjust stage. Thus, in an embodiment, the stage-wise mini-batch process can be applied to the forward and backward propagation stages.

In an embodiment, step 410 can include step 410A.

At step 410A, configure the stage-wise mini-batch process to wait for each of pre-designated ones (e.g., propagation stages) of the multiple training stages to complete using a system wait primitive to improve the cache utilization. In an embodiment, waiting for each of the predesignated ones of the multiple training stages to complete can be achieved by blocking (e.g., using a system wait primitive) all threads involved in each of the predesignated ones of the multiple training stages, at respective ends of each of the predesignated ones of the multiple training stages. In an embodiment, the system wait primitive can be a barrier operation. In an embodiment, the system wait primitive can be a fine-grained synchronization primitive.

In an embodiment, step 410A includes step 410A1.

At step 410A1, add a respective system wait primitive (e.g., a respective barrier operation, a respective fine-grained synchronization primitive, etc.) after each of the multiple training stages.

At step 420, receive an input image of a person to be recognized for a face recognition task.

At step 430, apply the trained neural network to the input image to recognize the person.

At step 440, perform an action responsive to a face recognition result. For example, a person may be permitted or restricted from something depending upon whether or not they were recognized. For example, a door(s) (or window(s)) may be locked to keep something in (or out), access to an object or place may be permitted or restricted, and so forth, as readily appreciated by one of ordinary skill in the art, given the teachings of the present invention provided herein, while maintaining the spirit of the present invention.

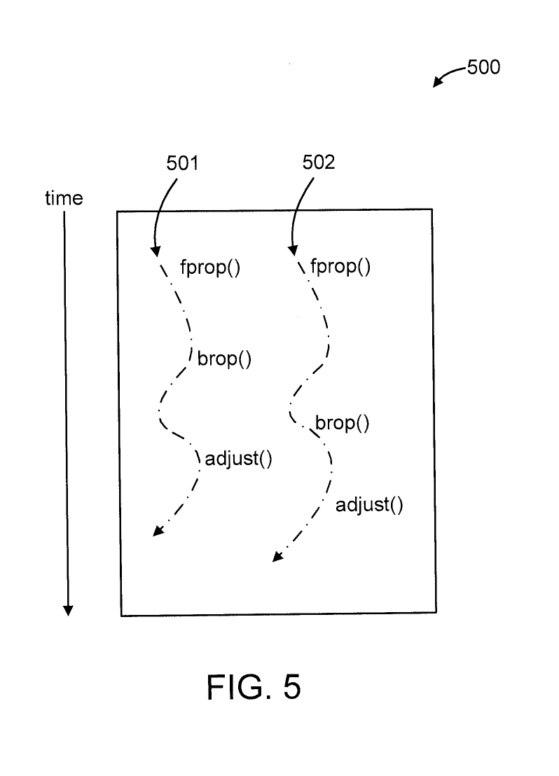

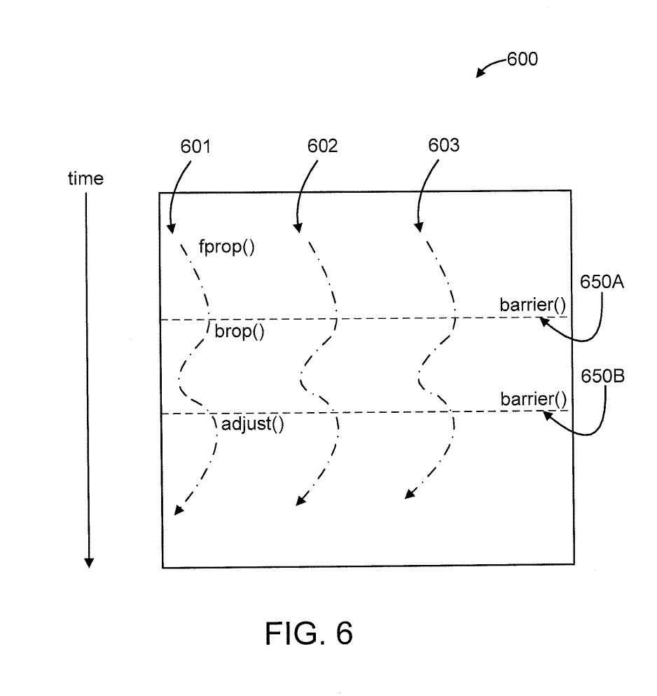

FIG. 5 shows an example of conventional mini-batching 500 to which the present invention can be applied, in accordance with an embodiment of the present invention. FIG. 6 shows an example of mini-batching 600 in accordance with an embodiment of the present invention.

In the examples of shown in FIGS. 5 and 6, each arrow (i.e., 501 and 502 in FIG. 5; 601, 602, and 603 in FIG. 6) represents an execution of a single example or a set of examples (usually OMP_NUM_THREADS) running and executing various stages of deep network training. Also, an arrow, indicating “TIME”, is shown in order to provide a timing indication of the various stages. Moreover, in the examples of FIGS. 5 and 6, “fprop( )” denotes the forward propagation stage, “bprop( )” denotes the backward propagation stage, and “adjust( )” denotes the adjust stage. Hence, timing-wise regarding the multiple stages of neural network training, fprop( ) is followed by bprop( ) which is then followed by adjust( ).

In the example of conventional mini-batching 500 shown in FIG. 5, no barrier operation is used at the end of each stage. Thus, each of the multiple threads can be processing different stages at the same time, thus adversely impacting cache utilization.

In the example of mini-batching 600 in accordance with an embodiment of the present invention, each of the fprop( ) and bprop( ) stages is followed by a respective barrier operation (650A and 650B, respectively) that forces all threads to wait until all the threads finish executing a specific stage (such as any of fprop, bprop( ) and adjust( )). This improves overall cache utilization by, e.g., providing all threads with a greater overlapping of the working set. Moreover, a higher throughput of trained samples per second is achieved.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims.

Having thus described aspects of the invention, with the details and particularity required by the patent laws, what is claimed and desired protected by Letters Patent is set forth in the appended claims:

1. A face recognition system, comprising:
a camera for capturing an input image of a face of a person to be recognized;
a cache; and
a set of one or more processors configured to (i) improve a utilization of the cache by the one or more processors during multiple training stages of a neural network configured to perform face recognition, by performing a stage-wise mini-batch process on a set of samples used for the multiple training stages, and (ii) recognize the person by applying the neural network to the input image during a recognition stage,
wherein the stage-wise mini-batch process waits for each of the multiple training stages to complete using a system wait primitive to improve the utilization of the cache.

2. The face recognition system of claim 1, wherein the system wait primitive is a barrier operation.

3. The face recognition system of claim 1, wherein the system wait primitive is a fine-grained synchronization primitive.

4. The face recognition system of claim 1, wherein the utilization of the cache is improved by adding a respective barrier operation after each of the multiple training stages.

5. The face recognition system of claim 1, wherein samples from the set are provided as respective inputs to at least one of the multiple training stages.

6. The face recognition system of claim 1, wherein the utilization of the cache is improved by blocking all threads involved in each of the multiple training stages at respective ends of each of the multiple training stages.

7. The face recognition system of claim 1, wherein the one or more processors comprise at least one graphics processing unit.

8. The face recognition system of claim 1, wherein the one or more processors comprise at least two separate processing devices in at least two computers of a distributed computer system.

9. The face recognition system of claim 1, wherein the stage-wise mini-batch process is applied to each of propagation stages of the multiple training stages, the multiple training stages including a forward propagation stage, a backward propagation stage, and an adjust stage.

10. A computer-implemented method for face recognition, comprising:
improving a cache utilization by one or more processors during multiple training stages of a neural network configured to perform face recognition, by performing a stage-wise mini-batch process on a set of samples used for the multiple training stages, wherein the stage-wise mini-batch process waits for each of the multiple training stages to complete using a system wait primitive to improve the cache utilization,
capturing, by a camera, an input image of a face of a person to be recognized; and
recognizing the person by applying the neural network to the input image during a recognition stage.

11. The computer-implemented method of claim 10, wherein the system wait primitive is a barrier operation.

12. The computer-implemented method of claim 10, wherein the system wait primitive is a fine-grained synchronization primitive.

13. The computer-implemented method of claim 10, wherein said improving step comprises adding a respective barrier operation after each of the multiple training stages.

14. The computer-implemented method of claim 10, wherein samples from the set are provided as respective inputs to at least one of the multiple training stages.

15. The computer-implemented method of claim 10, wherein said improving step blocks all threads involved in each of the multiple training stages at respective ends of each of the multiple training stages.

16. The computer-implemented method of claim 10, wherein the one or more processors comprise at least one graphics processing unit.

17. The computer-implemented method of claim 10, wherein the one or more processors comprise at least two separate processing devices in at least two computers of a distributed computer system.

18. The computer-implemented method of claim 10, wherein the stage-wise mini-batch process is applied to each of propagation stages of the multiple training stages, the multiple training stages including a forward propagation stage, a backward propagation stage, and an adjust stage.

19. A computer program product for face recognition, the computer program product comprising a non-transitory computer readable storage medium having program instructions embodied therewith, the program instructions executable by a computer to cause the computer to perform a method comprising:
improving a cache utilization by one or more processors during multiple training stages of a neural network configured to perform face recognition, by performing a stage-wise mini-batch process on a set of samples used for the multiple training stages, wherein the stage-wise mini-batch process waits for each of the multiple training stages to complete using a system wait primitive to improve the cache utilization,
capturing, by a camera, an input image of a face of a person to be recognized; and
recognizing the person by applying the neural network to the input image during a recognition stage.

20. The computer program product of claim 19, wherein the system wait primitive is a barrier operation.
